(19) United States
(12) Patent Application Publication
(10) Pub. No.: US 2025/0384892 A1
(43) Pub. Date: Dec. 18, 2025

(54) METHOD, APPARATUS AND TERMINAL DEVICE FOR AUDIO PROCESSING

(71) Applicant: DOUYIN VISION CO.,LTD., Beijing (CN)

(72) Inventors: Chuxiang SHANG, Beijing (CN); Xiaoxiao XIANG, Beijing (CN); Chengshuai ZHAO, Beijing (CN); Chuanzeng HUANG, Beijing (CN)

(21) Appl. No.: 18/877,781

(22) PCT Filed: Aug. 17, 2023
(86) PCT No.: PCT/CN2023/113597

§ 371 Date: Dec. 20, 2024

(30) Foreign Application Priority Data
Oct. 18, 2022 (CN) 202211275143.4

(51) Int. Cl. G10L 21/0232; G10L 21/0216; G10L 21/0272; G10L 25/18; G10L 25/30; G10L 25/93

(52) U.S. Cl. CPC G10L 21/0232; G10L 21/0272; G10L 25/18; G10L 25/30; G10L 25/93; G10L 2021/02166

(57) ABSTRACT

The disclosure provides a method, apparatus and terminal device for audio processing, and the method includes: obtaining a plurality of first audios captured by a plurality of audio capture devices; determining an angle feature for indicating a proportion of a sound source in a target direction in each first audio based on the plurality of first audios and the target direction; determining a second audio associated with the target direction based on the plurality of first audios and the angle feature; and playing the second audio.

### CROSS REFERENCE TO RELATED APPLICATIONS

This application claims priority to Chinese Patent Application No. 202211275143.4, entitled “METHOD, APPARATUS AND TERMINAL DEVICE FOR AUDIO PROCESSING” filed on Oct. 18, 2022, the entirety of which is incorporated herein by reference.

### FIELD

Embodiments of the present disclosure relate to the field of audio processing technologies, and in particular, to a method, apparatus and terminal device for audio processing.

### BACKGROUND

The terminal device may capture audio in space and play the audio. For example, in a conference scenario, a microphone in a terminal device may capture a voice of a user and send the voice to another terminal device.

Currently, a terminal device may capture audio in space by a microphone and send the captured audio to another terminal device for playing the audio. For example, a microphone in a conference room may capture a voice of a user, and a terminal device may obtain the voice from the microphone, and send the voice to another terminal device for playing the voice, thereby achieving the effect of remote conference calls. However, there is both target audio and non-target audio in space (e.g., audio associated with non-target objects or interfering audio). The presence of non-target audio in space results in poor audio playback effect or the played audio is not the audio that the user is interested in.

### SUMMARY

The present disclosure provides a method, apparatus and terminal device for audio processing, which are used for solving the technical problem of poor audio playback effect in the prior art.

In a first aspect, the present disclosure provides a method of audio processing, including: obtaining a plurality of first audios captured by a plurality of audio capture devices; determining an angle feature for indicating a proportion of a sound source in a target direction in each first audio based on the plurality of first audios and the target direction; determining a second audio associated with the target direction based on the plurality of first audios and the angle feature; and playing the second audio.

In a second aspect, the present disclosure provides an apparatus for audio processing, including an obtaining module, a first determining module, a second determining module and a playing module, wherein the obtaining module is configured to obtain a plurality of first audios captured by a plurality of audio capture devices; the first determining module is configured to determine an angle feature for indicating a proportion of a sound source in a target direction in each first audio based on the plurality of first audios and the target direction; the second determining module is configured to determine a second audio associated with the target direction based on the plurality of first audios and the angle feature; the playing module is configured to play the second audio.

In a third aspect, the embodiments of the present disclosure provide a terminal device, including: the memory storing computer execution instructions; the processor executing the computer execution instructions stored in the memory, to cause the processor to perform the method of audio processing according to the first aspect and various possible methods of audio processing related to the first aspect.

In a fourth aspect, the embodiments of the present disclosure provide a computer readable storage medium storing computer execution instructions that, when executed by a processor, implement the method of audio processing according to the first aspect and various possible methods of audio processing related to the first aspect.

In a fifth aspect, the embodiments of the present disclosure provide a computer program product, including a computer program which, when executed by a processor, implements the method of audio processing according to the first aspect and various possible methods of audio processing related to the first aspect.

In a sixth aspect, the embodiments of the present disclosure provide a computer program which, when executed by a processor, implements the method of audio processing according to the first aspect.

### BRIEF DESCRIPTION OF THE DRAWINGS

In order to more clearly illustrate the embodiments of the present disclosure or the technical solutions in the prior art, the accompanying drawings used in the description of the embodiments or the prior art will be briefly introduced below, and it will be apparent that the drawings in the following description are some embodiments of the present disclosure, and those skilled in the art may also obtain other drawings according to these drawings without creative effort.

FIG. 1 is a schematic diagram of an application scenario according to the embodiments of the present disclosure;

FIG. 2 is a schematic flowchart of a method of audio processing according to the embodiments of the present disclosure;

FIG. 3 is a schematic diagram of a process of determining a plurality of first phase differences according to the embodiments of the present disclosure;

FIG. 4 is a schematic diagram of a method of determining a second audio according to the embodiments of the present disclosure;

FIG. 5 is a schematic diagram of a process of determining first weights and second weights according to the embodiments of the present disclosure;

FIG. 6 is a schematic diagram of a process of determining a second audio according to the embodiments of the present disclosure;

FIG. 7 is a schematic diagram of a process of a method of audio processing according to the embodiments of the present disclosure;

FIG. 8 is a schematic structural diagram of an apparatus for audio processing according to the embodiments of the present disclosure; and

FIG. 9 is a schematic structural diagram of a terminal device according to the embodiments of the present disclosure.

### DETAILED DESCRIPTION

Example embodiments will be described in detail here, examples of which are illustrated in the accompanying drawings. The following description relates to the accompanying drawings, in which the same numerals indicate the same or similar elements unless otherwise indicated. The implementations described in the following example embodiments do not represent all implementations consistent with the present disclosure. In contrast, they are merely examples of apparatuses and methods consistent with some aspects of the disclosure as detailed in the appended claims.

For ease of understanding, the concepts involved in the embodiments of the present disclosure are described below.

The terminal device is a device having a wireless transceiver function. The terminal device may be deployed on land, including indoor or outdoor, handheld, wearable, or vehicle-mounted; or may be deployed on a water surface (for example, a ship, etc.). The terminal device may be a mobile phone, a portable android device (PAD), a computer with a wireless transceiver function, a virtual reality (VR) terminal device, an augmented reality (AR) terminal device, a wireless terminal in industrial control, a vehicle-mounted terminal device, a wireless terminal in self-driving, a wireless terminal device in a remote medical, a wireless terminal device in a smart grid, a wireless terminal device in transportation safety, a wireless terminal device in a smart city, a wireless terminal device in a smart home, a wearable terminal device, or the like. The terminal device in the embodiments of the present disclosure may also be referred to as a terminal, user equipment (UE), an access terminal device, a vehicle-mounted terminal, an industrial control terminal, a UE unit, a UE station, a mobile station, a moving station, a remote station, a remote terminal device, a mobile device, a UE terminal device, a wireless communication device, a UE agent, or a UE device. The terminal device may also be fixed or mobile.

In the related art, a terminal device may capture audio in a space by a microphone and send the captured audio to a further terminal device, so that the further terminal device plays the audio. For example, in a remote conference scenario, a microphone in a conference room may capture a voice of a participating user, and a terminal device in the conference room may obtain the voice of the participating user from the microphone and send the voice to a remotely connected terminal device, so that the remotely connected terminal device plays the voice of the participating user. However, if there are more non-target audios in the space, for example, if there is more environmental noise in the conference room, the noise of the audio captured by the microphone is relatively large, thereby resulting in poor audio playback effect.

To resolve a technical problem in the related art, the embodiments of the present disclosure provide a method of audio processing. The terminal device obtains a plurality of first audios captured by a plurality of audio capture devices, determines an angle feature for indicating a proportion of a sound source in a target direction in each first audio based on the plurality of first audios and the target direction, determines, based on the plurality of first audios and the angle feature, a first target audio associated with each first audio in the target direction, determines a non-target audio associated with each first audio in the target direction, and determines a second audio based on the plurality of first audios, the plurality of first target audios, and the non-target audios, and plays the second audio. Thus, the terminal device may enhance the first target audio effect in the first audio, suppress the non-target audio in the first audio, thereby reducing noise in the second audio and improving a playback effect of the second audio.

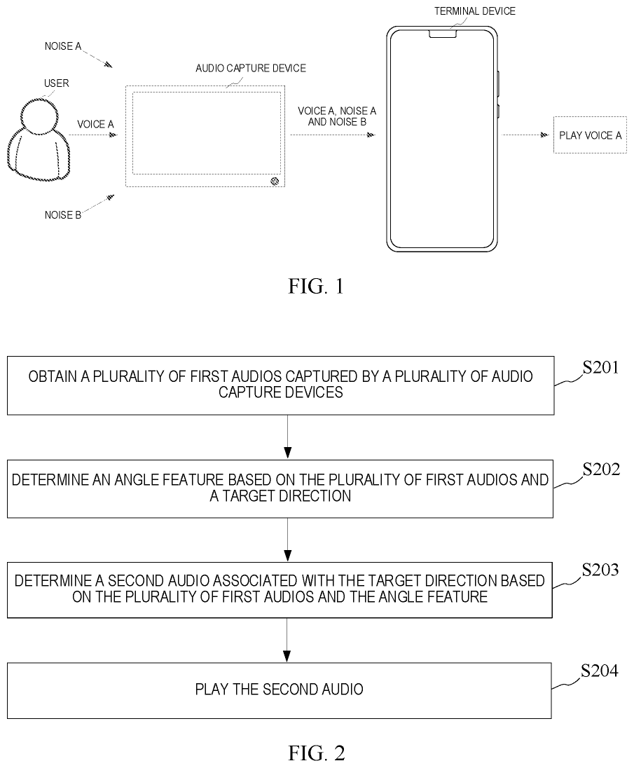

An application scenario of the embodiments of the present disclosure will be described below with reference to FIG. 1.

FIG. 1 is a schematic diagram of an application scenario according to the embodiments of the present disclosure. Referring to FIG. 1, FIG. 1 includes a user, an audio capture device, and a terminal device. The user issues a voice A to the audio capture device, and the audio capture device may further capture the noise A and the noise B in the environment. The audio capture device sends a mixed audio of the voice A, the noise A, and the noise B to the terminal device, and the terminal device may determine an angle feature of the mixed audio, determine the voice A of the user based on the mixed audio and the angle feature, and play the voice A. In this way, because the angle feature may indicate a proportion of the voice A in the mixed voice, the terminal device may amplify a signal of the voice A and suppress signals of the noise A and the noise B, thereby improving an audio playback effect.

It should be noted that FIG. 1 is merely an example application scenario of the embodiments of the present disclosure and is not a limitation on the application scenario of the embodiments of the present disclosure.

Technical solutions of the present disclosure and how the technical solutions of the present disclosure solve the aforementioned technical problems are described in detail below with reference to specific embodiments. The following several specific embodiments may be combined with each other, and the same or similar concepts or processes may not be repeated in some embodiments. The embodiments of the present disclosure will be described below with reference to the accompanying drawings.

FIG. 2 is a schematic flowchart of a method of audio processing according to the embodiments of the present disclosure. Referring to FIG. 2, the method may include the following steps.

At step S201, obtain a plurality of first audios captured by a plurality of audio capture devices.

The executing body of the embodiments of the present disclosure is a terminal device or an apparatus for audio processing disposed in the terminal device. The apparatus for audio processing may be implemented by software, and the apparatus for audio processing may also be implemented by combining software and hardware.

Optionally, the audio capture device is configured to capture audio in space. For example, the audio capture device may be a microphone. For example, the audio capture device may be a microphone in a conference room, or the audio capture device may be a microphone in a terminal device, which is not limited in the embodiments of the present disclosure.

Optionally, the first audio is an audio captured by the audio capture device. For example, in a conference scenario, a plurality of microphones may be disposed in the conference room, and the first audios may be audios captured by the plurality of microphones. For example, in a conference scenario, if a participating user issues a voice, a microphone in the conference room may capture the voice of the user and determine the voice of the user as the first audio.

Optionally, the terminal device may obtain a plurality of first audios by the audio capture device. For example, the terminal device may be connected to the plurality of audio capture devices, and when obtaining the plurality of first audios, the plurality of audio capture devices may send the plurality of first audios to the terminal device.

Optionally, the terminal device may obtain the plurality of first audios by a further terminal device. For example, the terminal device may be communicatively connected to the further terminal device. If a microphone in the further terminal device obtains the plurality of first audios, the further terminal device may send the plurality of first audios to the terminal device.

It should be noted that one audio capture device may capture one first audio. For example, if the space includes one sound source, and if the space includes one audio capture device, the audio capture device may capture one first audio for the sound source. If the space includes six audio capture devices, the six audio capture devices may capture six first audio for the sound source.

At step S202: determine an angle feature based on the plurality of first audios and a target direction.

Optionally, the angle feature is used to indicate a proportion of the sound source in the target direction in each first audio. For example, if the first audio obtained by the terminal device includes a first audio A and a first audio B, the angle feature is used to indicate a proportion of audio associated with the target direction in the first audio A and a proportion of audio associated with the target direction in the first audio B.

Optionally, the terminal device may determine the angle feature based on the following feasible implementation: determining phase differences between the plurality of first audios to obtain a plurality of first phase differences, determining a second phase difference associated with the target direction, and determining the angle feature based on the second phase difference and the plurality of first phase differences.

Optionally, determining the phase differences between the plurality of first audios is specifically: determining, by the terminal device, an initial audio in the plurality of first audios. Optionally, the terminal device may determine any of the plurality of first audios as the initial audio. For example, if the plurality of first audios obtained by the terminal device includes the first audio A, the first audio B, and the first audio C, the terminal device may determine the first audio A as the initial audio, the terminal device may determine the first audio B as the initial audio, or the terminal device may determine the first audio C as the initial audio.

Optionally, the phase differences between the initial audio and each first audio are obtained to obtain a plurality of first phase differences. For example, if the plurality of first audios captured by the terminal device include a first audio A, a first audio B, and a first audio C, and the terminal device determines that the initial audio is the first audio A, the terminal device may obtain a phase difference A between the first audio A and the first audio B, and the terminal device may obtain a phase difference B between the first audio A and the first audio C, and then determine the phase difference A and the phase difference B as the first phase difference.

It should be noted that in the embodiments of this disclosure, if the terminal device determines the angle feature by the plurality of first audios and the target direction, the terminal device may first perform Fourier transform on the plurality of first audios, to obtain a plurality of frequency spectrums associated with the plurality of first audios, and then determine the plurality of first phase differences by the plurality of frequency spectrums. In this way, the accuracy of determining the first phase difference can be improved, the accurate angle feature can be obtained, and the audio processing effect can be improved.

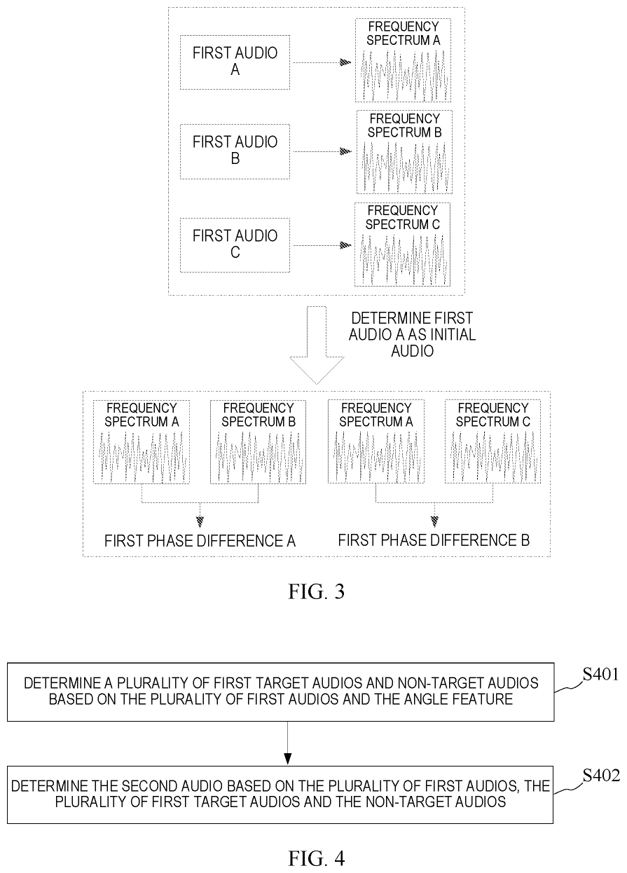

The following describes a process of determining a plurality of first phase differences with reference to FIG. 3.

FIG. 3 is a schematic diagram of a process of determining a plurality of first phase differences according to the embodiments of the present disclosure. Referring to FIG. 3, a first audio A, a first audio B, and a first audio C are included. Fourier transform processing is performed on the first audio A, the first audio B, and the first audio C, to obtain a frequency spectrum A associated with the first audio A, a frequency spectrum B associated with the first audio B, and a frequency spectrum C associated with the first audio C. The first audio A is determined as the initial audio, a phase difference between the frequency spectrum A and the frequency spectrum B is determined as the first phase difference A, and a phase difference between the frequency spectrum A and the frequency spectrum C is determined as the first phase difference B.

Optionally, the terminal device may determine the phase difference between the sound source in the target direction and the audio capture device as a second phase difference associated with the target direction. For example, the second phase difference associated with the target direction is a phase difference caused by a distance difference between the sound source in the target direction and the microphone, and the phase difference is the target phase difference.

Optionally, determining the angle feature based on the second phase difference and the plurality of first phase differences is specifically: determining cosine similarities between the second phase difference and each first phase difference to obtain a plurality of cosine similarities. For example, if the second phase difference associated with the target direction is a phase difference A, and the first phase difference includes a phase difference B and a phase difference C, the plurality of cosine similarities includes a cosine similarity between the phase difference A and the phase difference B and a cosine similarity between the phase difference A and the phase difference C.

The plurality of cosine similarities is performed fusion processing to obtain the angle feature. For example, the terminal device may splice the plurality of cosine similarities to obtain the angle feature, or the terminal device may superpose the plurality of cosine similarities to obtain the angle feature. For example, the terminal device may splice the cosine similarity A and the cosine similarity B to obtain the angle feature.

Optionally, the terminal device may determine the target direction in response to a touch operation of the user. For example, the terminal device may determine, based on a touch operation performed by the user on any position on a video conference display screen, a direction in space corresponding to the position touched by the user as the target direction.

Optionally, the terminal device may determine the target direction in response to a voice operation of the user. For example, when a user A issues a voice of “user B, speak please”, the terminal device may determine a position of the user B as the target direction. It should be noted that the terminal device may also determine the target direction in another manner, which is not limited in the embodiments of the present disclosure.

At step S203, determine a second audio associated with the target direction based on the plurality of first audios and the angle feature.

Optionally, the second audio is an audio obtained by the terminal device in the target direction. For example, the sound source in the space is located in the north direction of the microphone, and if the target direction is the east direction, the second audio is an audio of the sound source in the east direction.

Optionally, the terminal device may determine, based on the following feasible implementation, the second audio associated with the target direction: determining a plurality of first target audios and non-target audios based on the plurality of first audios and the angle feature, and determining the second audio based on the plurality of first audios, the plurality of first target audios, and the non-target audios. Optionally, the first target audios are audios associated with the first audios in the target direction, and the non-target audios are audios associated with the first audios in a further direction. For example, because the angle feature may indicate a proportion of the sound source in the target direction in each first audio, the first target audio of each first audio in the target direction and the non-target audio (an audio in a further direction) of each first audio in the target direction may be obtained by using the angle feature and the plurality of first audios.

At step S204: play the second audio.

Optionally, after performing fusion processing on the plurality of sub-audios to obtain the second audio, the terminal device may play the second audio.

Optionally, after obtaining the second audio, the terminal device may further send the second audio to a further terminal device or a server, which is not limited in this embodiment of the present disclosure.

The embodiments of the present disclosure provides a method of audio processing, and the terminal device obtains a plurality of first audios captured by a plurality of audio capture devices, determines an angle feature based on the plurality of first audios and a target direction, determines a first target audio associated with each first audio in the target direction based on the plurality of first audios and the angle features, determines a non-target audio associated with each first audio in the target direction, processing the plurality of first target audios and non-target audios based on a second model to obtain a plurality of target weights, determines a plurality of sub-audios based on the plurality of target weights and the plurality of first audios, performs fusion processing on the plurality of sub-audios to obtain the second audio, and plays the second audio. In the foregoing method, because the angle feature may indicate a proportion of the sound source in the target direction in each first audio, the terminal device may enhance a first target audio effect in the first audio, suppress the non-target audio in the first audio, thereby reducing noise in the second audio and improving a playback effect of the second audio.

Based on the embodiment shown in FIG. 2, a process of determining the second audio associated with the target direction based on the plurality of first audios and the angle feature in the method of audio processing is described in detail below with reference to FIG. 4.

FIG. 4 is a schematic diagram of a method of determining a second audio according to the embodiments of the present disclosure. Referring to FIG. 4, the method includes the following steps.

At step S401: determine a plurality of first target audios and non-target audios based on the plurality of first audios and the angle feature.

Optionally, the first target audio is an audio associated with the first audio in the target direction, and the non-target audio is an audio associated with the first audio in a further direction. For example, each first audio includes one first target audio and one non-target audio. For example, if the terminal device obtains six first audios through the audio capture device, the terminal device may obtain six first target audios and six non-target audios.

Optionally, the terminal device may determine the plurality of first target audios and non-target audios based on the following feasible implementations: determining, based on the plurality of first audios and the angle feature, a plurality of first weights and a plurality of second weights associated with the plurality of first audios; and determining the plurality of first target audios and the non-target audios based on the plurality of first weights, the plurality of second weights, and the plurality of first audios. Optionally, the first weight may be a weight of an audio in the target direction in the first audio, and the second weight may be a weight of audios in other directions in the first audio.

Optionally, determining the plurality of first weights and the plurality of second weights associated with the plurality of first audios based on the plurality of first audios and the angle feature is specifically: determining the plurality of first weights and the plurality of second weights based on a first model, the plurality of first audios, and the angle feature. Optionally, the first model is obtained by training a plurality of groups of first samples, and the plurality of groups of first samples comprise a plurality of sample audios, angle features associated with the plurality of sample audios, and a sample first weight and a sample second weight associated with each sample audio. For example, a sample audio 1 and a sample angle feature 1 associated with the sample audio 1 are obtained, and a sample first weight 1 and a sample second weight 1 associated with each sample audio are obtained, where the group of first samples includes the sample audio 1, the sample angle feature 1, the sample first weight 1, and the sample second weight 1.

Optionally, a structure of the first model may include an encoder, a dual path recurrent neural network (DPRNN), and a decoder. For example, the DPRNN may effectively model a correlation between frequencies of the audios and a correlation between frames of the audios, so that the audio may be effectively decomposed. The encoder is configured to encode angle features and features of a plurality of frequency spectrums. The DPRNN may be composed of stacked SA-DPRNN blocks and adaptive feature fusion blocks (AFFBs). The SA-DPRNN blocks include an intra-block recurrent neural network (RNN) and an inter-block RNN. The AFFB allocates different weights to contributions of a training task according to different intermediate features, so that different intermediate features may be adaptively aggregated. An attention mechanism may be introduced into the DPRNN, and a training effect of the model may be improved.

Optionally, if the plurality of first audios and the angle feature are processed by the first model, Fourier transform processing may be performed on the plurality of first audios to obtain a plurality of frequency spectrum charts corresponding to the plurality of first audios. Fused frequency spectrum features of the plurality of frequency spectrum charts are extracted by the first model. The fused frequency spectrum features and the angle features are spliced, and then the spliced features are processed to obtain a plurality of first weights and a plurality of second weights associated with the plurality of first audios. For example, the terminal device inputs six frequency spectrum charts and angle features corresponding to six first audios to the first model, and the first model may extract fused frequency spectrum features from the six frequency spectrums, splice the fused frequency spectrum features and the angle features to obtain spliced features, and perform convolution processing on the spliced features to obtain six first weights and six second weights.

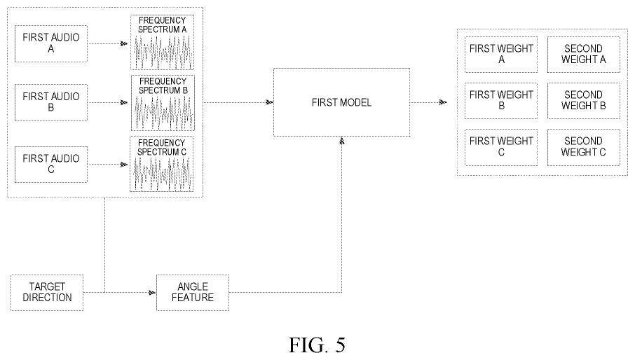

The following describes a process of determining a plurality of first weights and a plurality of second weights with reference to FIG. 5.

FIG. 5 is a schematic diagram of a process of determining first weights and second weights according to the embodiments of the present disclosure. Referring to FIG. 5, a first audio A, a first audio B, a first audio C, a target direction, and a first model are included. Fourier transform processing is performed on the first audio A, the first audio B, and the first audio C, to obtain a frequency spectrum A associated with the first audio A, a frequency spectrum B associated with the first audio B, and a frequency spectrum C associated with the first audio C.

Referring to FIG. 5, an angle feature is determined by the frequency spectrum A, the frequency spectrum B, the frequency spectrum C, and the target direction, and the angle feature, the frequency spectrum A, the frequency spectrum B, and the frequency spectrum C are input to the first model. The first model may output a first weight A, a first weight B, a first weight C, a second weight A, a second weight B and a second weight C. The first weight A and the second weight A are weights associated with the first audio A, the first weight B and the second weight B are weights associated with the first audio B, and the first weight C and the second weight C are weights associated with the first audio C.

Optionally, determining the plurality of first target audios and the non-target audios based on the plurality of first weights, the plurality of second weights, and the plurality of first audios includes: determining the plurality of first target audios based on the plurality of first weights and the plurality of first audios. For example, each first audio is multiplied by a corresponding first weight to obtain a first target audio corresponding to the first audio, and a plurality of first target audios associated with the plurality of first audios may be obtained by using this method. For example, if the first weight corresponding to the first audio A is the weight A, and the first weight corresponding to the first audio B is the weight B, a product of the first audio A and the weight A is determined as the first target audio associated with the first audio A, and a product of the first audio B and the weight B is determined as the first target audio associated with the first audio B.

Optionally, the non-target audios are determined based on the plurality of second weights and the plurality of first audios. For example, each first audio is multiplied by the corresponding second weight to obtain the non-target audio corresponding to the first audio, and the plurality of non-target audio associated with the plurality of first audios may be obtained by using this method. For example, if a second weight corresponding to a first audio 1 is the weight 1, and a second weight corresponding to a first audio 2 is the weight 2, a product of the first audio 1 and the weight 1 is determined as the non-target audio associated with the first audio 1, and a product of the first audio 2 and the weight 2 is determined as the non-target audio associated with the first audio 2.

At step S402: determine the second audio based on the plurality of first audios, the plurality of first target audios and the non-target audios.

Optionally, the terminal device may determine the second audio based on the following feasible implementation: processing the plurality of first target audios and the non-target audios based on the second model, to obtain a plurality of target weights. Optionally, the target weights are proportions of audios associated with the target direction in each frequency point of the first audio. For example, the target weight may be a weight vector. If the first audio includes 100 frequency points, the weight vector includes 100 sub-vectors. If the first audio includes 1000 frequency points, the weight vector includes 1000 sub-vectors.

Optionally, the second model is obtained by training a plurality of groups of second samples, where the plurality of groups of second samples includes a plurality of sample first target audios, a plurality of sample non-target audios associated with the plurality of sample first target audios, and a plurality of sample target weights. For example, a sample first target audio 1, a sample non-target audio 1 and a sample weight 1 associated with the sample first target audio 1 are obtained to obtain a group of second samples, where the group of second samples includes the sample first target audio 1, the sample non-target audio 1, and the sample weight 1.

A plurality of sub-audios is determined based on the plurality of target weights and the plurality of first audios, and the plurality of sub-audios are performed fusion processing to obtain the second audio. For example, after processing the 6 first target audios and the 6 non-target audios by using the second model, the terminal device obtains 6 target weights. Each first audio corresponds to 1 target weight. By multiplying the 6 first audios by the associated 6 target weights, 6 sub-audios are obtained. The 6 sub-audios are synthesized to obtain the second audio.

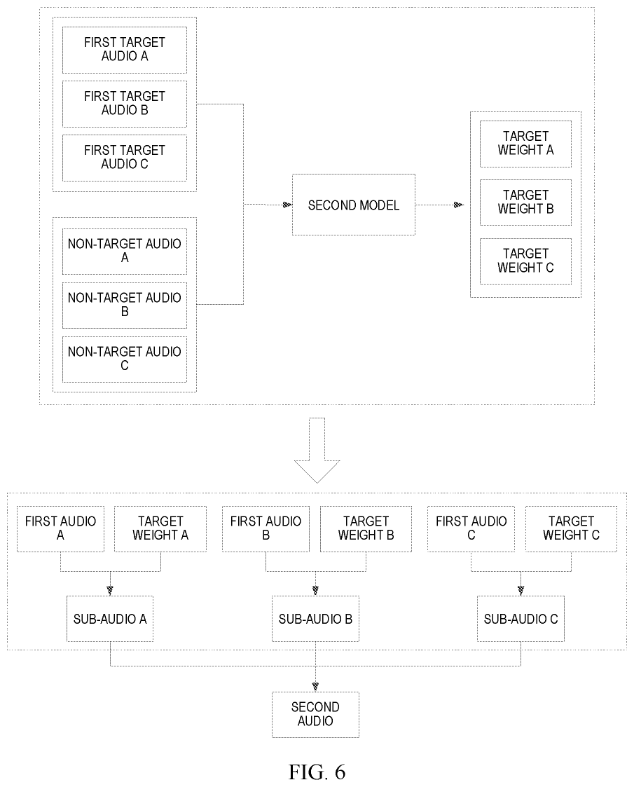

The process of determining a second audio is described below with reference to FIG. 6.

FIG. 6 is a schematic diagram of a process of determining a second audio according to the embodiments of the present disclosure. Referring to FIG. 6, a first target audio A, a first target audio B, a first target audio C, a non-target audio A, a non-target audio B, a non-target audio C, and a second model are included. The first target audio A, the first target audio B, the first target audio C, the non-target audio A, the non-target audio B, and the non-target audio C are input into the second model, and the second model may output a target weight A, a target weight B, and a target weight C.

Referring to FIG. 6, a product of the first audio A and the target weight A is determined as a sub-audio A, a product of the first audio B and the target weight B is determined as a sub-audio B, a product of the first audio C and the target weight C is determined as a sub-audio C, and fusion processing is performed on the sub-audio A, the sub-audio B, and the sub-audio C to obtain the second audio.

The embodiments of the present disclosure provide a method of determining a second audio, and the method includes: determining, based on the plurality of first audios and the angle feature, a plurality of first weights and a plurality of second weights associated with the plurality of first audios, determining the plurality of first target audios and the non-target audios based on the plurality of first weights, the plurality of second weights, and the plurality of first audios, and determining the second audio based on the plurality of first audios, the plurality of first target audios and the non-target audios. In this way, because the first weight may indicate a proportion of audio in the target direction in the first audio, and the second weight may indicate a proportion of audio in a further direction in the first audio, the terminal device may enhance a first target audio effect in the first audio, suppress the non-target audio in the first audio, thereby reducing noise in the second audio and improving a playback effect of the second audio.

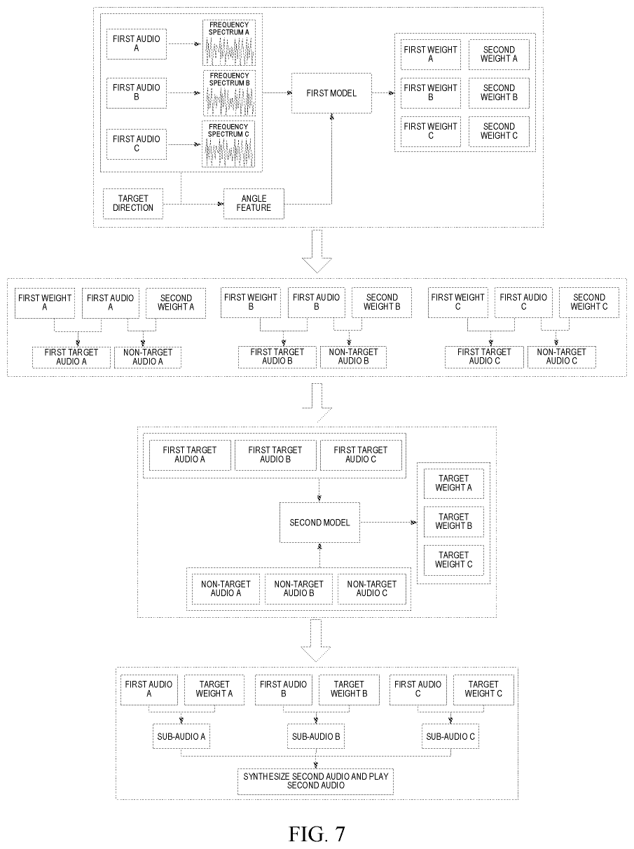

Based on any of the foregoing embodiments, the following describes a process of the foregoing method of audio processing with reference to FIG. 7.

FIG. 7 is a schematic diagram of a process of a method of audio processing according to the embodiments of the present disclosure. Referring to FIG. 7, a first audio A, a first audio B, a first audio C, a target direction, a first model, and a second model are included. Fourier transform processing is performed on the first audio A, the first audio B, and the first audio C, to obtain a frequency spectrum A associated with the first audio A, a frequency spectrum B associated with the first audio B, and a frequency spectrum C associated with the first audio C.

Referring to FIG. 7, an angle feature is determined by the frequency spectrum A, the frequency spectrum B, the frequency spectrum C, and the target direction, and the angle feature, the frequency spectrum A, the frequency spectrum B, and the frequency spectrum C are input to the first model. The first model may output a first weight A, a first weight B, a first weight C, a second weight A, a second weight B and a second weight C. The first weight A and the second weight A are weights associated with the first audio A, the first weight B and the second weight B are weights associated with the first audio B, and the first weight C and the second weight C are weights associated with the first audio C.

Referring to FIG. 7, a product of the first audio A and the first weight A is determined as a first target audio A. A product of the first audio A and the second weight A is determined as a non-target audio A. A product of the first audio B and the first weight B is determined as a first target audio B. A product of the first audio B and the second weight B is determined as a non-target audio B. A product of the first audio C and the first weight C is determined as a first target audio C. A product of the first audio C and the second weight C is determined as a non-target audio C.

Referring to FIG. 7, the first target audio A, the first target audio B, the first target audio C, the non-target audio A, the non-target audio B, and the non-target audio C are input into a second model, and the second model may output a target weight A, a target weight B, and a target weight C. A product of the first audio A and the target weight A is determined as a sub-audio A. A product of the first audio B and the target weight B is determined as a sub-audio B. A product of the first audio C and the target weight C is determined as a sub-audio C. The sub-audio A, the sub-audio B, and the sub-audio C are synthesized to obtain a second audio, and the second audio is played.

In this way, because the first weight may indicate a proportion of audio in the target direction in the first audio, and the second weight may indicate a proportion of audio in another direction in the first audio, the terminal device may enhance a first target audio effect in the first audio, suppress the non-target audio in the first audio, thereby reducing noise in the second audio and improving a playback effect of the second audio.

FIG. 8 is a schematic structural diagram of an apparatus for audio processing according to the embodiments of the present disclosure. Referring to FIG. 8, the apparatus for audio processing 800 includes an obtaining module 801, a first determining module 802, a second determining module 803, and a playing module 804.

The obtaining module 801 is configured to obtain a plurality of first audios captured by a plurality of audio capture devices.

The first determining module 802 is configured to determine an angle feature for indicating a proportion of a sound source in a target direction in each first audio based on the plurality of first audios and the target direction.

The second determining module 803 is configured to determine a second audio associated with the target direction based on the plurality of first audios and the angle feature.

The playing module 804 is configured to play the second audio.

According to one or more embodiments of the present disclosure, the second determining module 803 is specifically configured to: determine a plurality of first target audios and non-target audios based on the plurality of first audios and the angle feature, the first target audios being audios associated with the first audios in the target direction, and the non-target audios being audios associated with the first audios in further directions; and determine the second audio based on the plurality of first audios, the plurality of first target audios and the non-target audios.

According to one or more embodiments of the present disclosure, the second determining module 803 is specifically configured to: determine, based on the plurality of first audios and the angle feature, a plurality of first weights and a plurality of second weights associated with the plurality of first audios; and determine the plurality of first target audios and the non-target audios based on the plurality of first weights, the plurality of second weights, and the plurality of first audios.

According to one or more embodiments of the present disclosure, the second determining module 803 is specifically configured to: determine the plurality of first target audios based on the plurality of first weights and the plurality of first audios; and determine the non-target audios based on the plurality of second weights and the plurality of first audios.

According to one or more embodiments of the present disclosure, the second determining module 803 is specifically configured to: determine the plurality of first weights and the plurality of second weights based on a first model, the plurality of first audios, and the angle feature; wherein the first model is obtained by training a plurality of groups of first samples, and the plurality of groups of first samples comprise a plurality of sample audios, angle features associated with the plurality of sample audios, and a sample first weight and a sample second weight associated with each sample audio.

According to one or more embodiments of the present disclosure, the second determining module 803 is specifically configured to: process, based on a second model, the plurality of first target audios and the non-target audios to obtain a plurality of target weights, the target weights being proportions of audios associated with the target direction in each frequency point of the first audio; and determine a plurality of sub-audios based on the plurality of target weights and the plurality of first audios, and performing fusion processing on the plurality of sub-audios to obtain the second audio; wherein the second model is obtained by training a plurality of groups of second samples, and the plurality of groups of second samples comprise a plurality of sample first target audios, a plurality of sample non-target audios associated with the plurality of sample first target audios, and a plurality of sample target weights.

According to one or more embodiments of the present disclosure, the first determining module 802 is specifically configured to: determine phase differences between the plurality of first audios to obtain a plurality of first phase differences; determine a second phase difference associated with the target direction; and determine the angle feature based on the second phase difference and the plurality of first phase differences.

According to one or more embodiments of the present disclosure, the first determining module 802 is specifically configured to: determine cosine similarities between the second phase difference and each first phase difference to obtain a plurality of cosine similarities; and perform fusion processing on the plurality of cosine similarities to obtain the angle feature.

The apparatus for audio processing provided in the embodiments of the present disclosure may be configured to perform the technical solutions of the foregoing method embodiments, and implementation principles and technical effects thereof are similar, and details are not described herein again in this embodiment.

The embodiments of the present disclosure further provide a computer readable storage medium storing computer execution instructions that, when executed by a processor, cause the processor to perform the method according to the foregoing method embodiments.

The embodiments of the present disclosure further provide a computer program, which, when executed by a processor, implements the method described in the foregoing method embodiments.

The embodiments of the present disclosure further provide a computer program product, including a computer program which, when executed by a processor, implements the method described in the foregoing method embodiments.

The present disclosure provides a method, apparatus and terminal device for audio processing. The terminal device obtains a plurality of first audios captured by a plurality of audio capture devices, determines an angle feature for indicating a proportion of a sound source in a target direction in each first audio based on the plurality of first audios and the target direction, determines a second audio associated with the target direction based on the plurality of first audios and the angle feature, and plays the second audio. In the foregoing method, because the angle feature may indicate a proportion of the sound source in the target direction in each first audio, the terminal device may determine an audio in the target direction that needs to be retained in the first audio and an audio in another direction that needs to be suppressed in the first audio, thereby reducing noise in the second audio and improving a playback effect of the second audio.

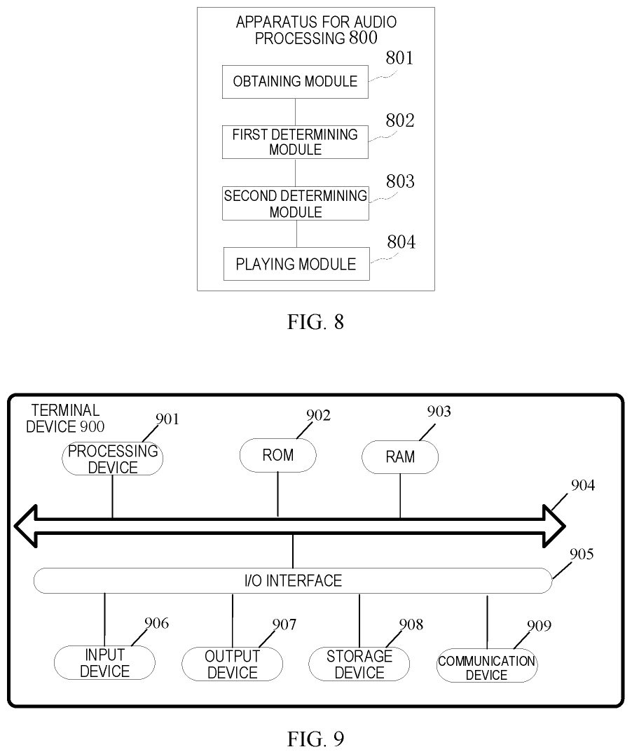

FIG. 9 is a schematic structural diagram of a terminal device according to the embodiments of the present disclosure. FIG. 9 is a schematic structural diagram of a terminal device 900 suitable for implementing embodiments of the present disclosure. The terminal device may include, but is not limited to, a mobile terminal such as a mobile phone, a laptop, a digital broadcast receiver, a personal digital assistant (PDA), a Portable Android Device (PAD), a portable multimedia player (PMP), an in-vehicle terminal (for example, a car navigation terminal), and a fixed terminal such as a digital TV, a desktop computer, or the like. The terminal device shown in FIG. 9 is merely an example and should not impose any limitation on the functionality and use ranges of the embodiments of the present disclosure.

As shown in FIG. 9, the terminal device 900 may include a processing device (for example, a central processing unit or a graphics processor) 901, and may perform various appropriate actions and processing according to a program stored in a read-only memory (ROM) 902 or a program loaded into a random-access memory (RAM) 903 from a storage device 908. In the RAM 903, various programs and data required by the operation of the terminal device 900 are also stored. The processing device 901, the ROM 902, and the RAM 903 are connected to each other through a bus 904. An input/output (I/O) interface 905 is also connected to the bus 904.

Generally, the following devices may be connected to the I/O interface 905: an input device 906 including, for example, a touch screen, a touch pad, a keyboard, a mouse, a camera, a microphone, an accelerometer, a gyroscope, etc.; an output device 907 including, for example, a liquid crystal display (LCD), a speaker, a vibrator, etc.; a storage device 908 including, for example, a magnetic tape, a hard disk, etc.; and a communication device 909. The communication device 909 may allow the terminal device 900 to communicate wirelessly or wired with other devices to exchange data. Although FIG. 9 illustrates a terminal device 900 having various devices, it should be understood that all illustrated devices are not required to be implemented or provided. More or fewer devices may alternatively be implemented or provided.

In particular, according to the embodiments of the present disclosure, the process described above with reference to the flowchart may be implemented as a computer software program. For example, embodiments of the present disclosure include a computer program product comprising a computer program embodied on a computer readable medium, the computer program comprising program code for performing the method shown in the flowchart. In such embodiments, the computer program may be downloaded and installed from the network through the communication device 909, or installed from the storage device 908, or from the ROM 902. When the computer program is executed by the processing device 901, the foregoing functions defined in the method of the embodiments of the present disclosure are performed.

It should be noted that the computer readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. More specific examples of the computer-readable storage medium may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination thereof. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted by any suitable medium, including but not limited to: wires, optical cables, Radio Frequency (RF), and the like, or any suitable combination thereof.

The computer readable medium may be included in the foregoing terminal device, or may exist separately, and is not assembled into the terminal device.

The computer readable medium carries one or more programs, and when the one or more programs are executed by the terminal device, the terminal device performs the method shown in the foregoing embodiments.

Computer program code for performing the operations of the present disclosure may be written in one or more programming languages, including object oriented programming languages, such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (for example, using an Internet service provider for Internet connection).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. In some cases, the name of a unit does not constitute a limitation on the unit itself. For example, a first obtaining unit may be further described as “obtaining at least two units of Internet Protocol addresses”.

The functions described above may be performed, at least in part, by one or more hardware logic components. For example, without limitation, the example types of hardware logic components that may be used include: a field programmable gate array (FPGA), an application specific integrated circuit (ASIC for short), an application specific standard product (ASSP), a system on chip (SoC for short), a complex programmable logic device (Complex Programmable Logic Device, CPLD for short), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

It should be noted that the modification of “a” and “a plurality” mentioned in this disclosure is illustrative and not limiting, and those skilled in the art should understand that “one or more” should be understood unless the context clearly indicates otherwise.

The names of messages or information exchanged between multiple devices in embodiments of the present disclosure are for illustrative purposes only and are not intended to limit the scope of such messages or information.

It can be understood that, before the technical solutions disclosed in the embodiments of the present disclosure are used, the types of personal information related to the present disclosure, the usage scope, the usage scenario and the like should be notified to the user in an appropriate manner according to the relevant laws and regulations and obtain the authorization of the user.

For example, in response to receiving an active request from a user, prompt information is sent to the user to explicitly prompt the user that the requested operation will need to acquire and use the personal information of the user. Therefore, the user can autonomously select whether to provide personal information to software or hardware such as terminal devices, applications, servers, or storage media that perform the operation of the technical solution of the present disclosure according to the prompt information.

As an optional but non-limiting implementation, in response to receiving the active request of the user, the manner of sending the prompt information to the user may be, for example, a pop-up window, and the prompt information may be presented in a text manner in the pop-up window. In addition, the pop-up window may further carry a selection control for the user to select “agree” or “not agree” to provide personal information to the terminal device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

It may be understood that the data involved in the technical solution (including but not limited to the data itself, the acquisition or use of the data) should follow the requirements of the corresponding laws and regulations and related regulations. The data may include information, parameters, messages, and the like, such as flow cut indication information.

The above description is only the preferred embodiments of this disclosure, and an explanation of the technical principles used. Those skilled in the art should understand that the scope of disclosure referred to in this disclosure is not limited to technical solutions formed by specific combinations of the aforementioned technical features, but also covers other technical solutions formed by arbitrary combinations of the aforementioned technical features or their equivalent features without departing from the aforementioned disclosed concept. For example, a technical solution formed by replacing the above features with (but not limited to) technical features with similar functions disclosed in this disclosure.

Furthermore, although each operation is depicted in a specific order, this should not be understood as requiring them to be executed in the specific order shown or in a sequential order. In certain environments, multitasking and parallel processing may be advantageous. Similarly, although several specific implementation details are included in the above discussion, these should not be interpreted as limiting the scope of this disclosure. Some features described in the context of individual embodiments can also be combined and implemented in a single embodiment. On the contrary, various features described in the context of a single embodiment can also be implemented individually or in any suitable sub combination in multiple embodiments.

Although the subject matter has been described in language specific to structural features and/or method logical actions, it should be understood that the subject matter limited in the attached claims may not necessarily be limited to the specific features or actions described above. On the contrary, the specific features and actions described above are only example forms of implementing the claims.

1. A method of audio processing, comprising:
obtaining a plurality of first audios captured by a plurality of audio capture devices;
determining an angle feature for indicating a proportion of a sound source in a target direction in each first audio based on the plurality of first audios and the target direction;
determining a second audio associated with the target direction based on the plurality of first audios and the angle feature; and
playing the second audio.

2. The method of claim 1, wherein determining the second audio associated with the target direction based on the plurality of first audios and the angle feature comprises:
determining a plurality of first target audios and non-target audios based on the plurality of first audios and the angle feature, the first target audios being audios associated with the first audios in the target direction, and the non-target audios being audios associated with the first audios in further directions; and
determining the second audio based on the plurality of first audios, the plurality of first target audios and the non-target audios.

3. The method of claim 2, wherein determining the plurality of first target audios and non-target audios based on the plurality of first audios and the angle feature comprises:
determining, based on the plurality of first audios and the angle feature, a plurality of first weights and a plurality of second weights associated with the plurality of first audios; and
determining the plurality of first target audios and the non-target audios based on the plurality of first weights, the plurality of second weights, and the plurality of first audios.

4. The method of claim 3, wherein determining the plurality of first target audios and the non-target audios based on the plurality of first weights, the plurality of second weights, and the plurality of first audios comprises:
determining the plurality of first target audios based on the plurality of first weights and the plurality of first audios; and
determining the non-target audios based on the plurality of second weights and the plurality of first audios.

5. The method of claim 3, wherein determining the plurality of first weights and the plurality of second weights associated with the plurality of first audios based on the plurality of first audios and the angle feature comprises:
determining the plurality of first weights and the plurality of second weights based on a first model, the plurality of first audios, and the angle feature;
wherein the first model is obtained by training a plurality of groups of first samples, and the plurality of groups of first samples comprise a plurality of sample audios, angle features associated with the plurality of sample audios, and a sample first weight and a sample second weight associated with each sample audio.

6. The method of claim 2, wherein determining the second audio based on the plurality of first audios, the plurality of first target audios, and the non-target audios comprises:
processing, based on a second model, the plurality of first target audios and the non-target audios to obtain a plurality of target weights, the target weights being proportions of audios associated with the target direction in each frequency point of the first audio; and
determining a plurality of sub-audios based on the plurality of target weights and the plurality of first audios, and performing fusion processing on the plurality of sub-audios to obtain the second audio;
wherein the second model is obtained by training a plurality of groups of second samples, and the plurality of groups of second samples comprise a plurality of sample first target audios, a plurality of sample non-target audios associated with the plurality of sample first target audios, and a plurality of sample target weights.

7. The method of claim 1, wherein determining the angle feature based on the plurality of first audios and the target direction comprises:
determining phase differences between the plurality of first audios to obtain a plurality of first phase differences;
determining a second phase difference associated with the target direction; and
determining the angle feature based on the second phase difference and the plurality of first phase differences.

8. The method of claim 7, wherein determining the angle feature based on the second phase difference and the plurality of first phase differences comprises:
determining cosine similarities between the second phase difference and each first phase difference to obtain a plurality of cosine similarities; and
performing fusion processing on the plurality of cosine similarities to obtain the angle feature.

9. (canceled)

10. (canceled)

11. (canceled)

12. (canceled)

13. (canceled)

14. A terminal device, comprising: a processor and a memory;
the memory storing computer execution instructions;
the processor executing the computer execution instructions stored in the memory, to cause the processor to perform acts for audio processing, the acts comprising:
obtaining a plurality of first audios captured by a plurality of audio capture devices;
determining an angle feature for indicating a proportion of a sound source in a target direction in each first audio based on the plurality of first audios and the target direction;
determining a second audio associated with the target direction based on the plurality of first audios and the angle feature; and
playing the second audio.

15. The terminal device of claim 14, wherein determining the second audio associated with the target direction based on the plurality of first audios and the angle feature comprises:
determining a plurality of first target audios and non-target audios based on the plurality of first audios and the angle feature, the first target audios being audios associated with the first audios in the target direction, and the non-target audios being audios associated with the first audios in further directions; and
determining the second audio based on the plurality of first audios, the plurality of first target audios and the non-target audios.

16. The terminal device of claim 15, wherein determining the plurality of first target audios and non-target audios based on the plurality of first audios and the angle feature comprises:
determining, based on the plurality of first audios and the angle feature, a plurality of first weights and a plurality of second weights associated with the plurality of first audios; and
determining the plurality of first target audios and the non-target audios based on the plurality of first weights, the plurality of second weights, and the plurality of first audios.

17. The terminal device of claim 16, wherein determining the plurality of first target audios and the non-target audios based on the plurality of first weights, the plurality of second weights, and the plurality of first audios comprises:
determining the plurality of first target audios based on the plurality of first weights and the plurality of first audios; and
determining the non-target audios based on the plurality of second weights and the plurality of first audios.

18. The terminal device of claim 16, wherein determining the plurality of first weights and the plurality of second weights associated with the plurality of first audios based on the plurality of first audios and the angle feature comprises:
determining the plurality of first weights and the plurality of second weights based on a first model, the plurality of first audios, and the angle feature;
wherein the first model is obtained by training a plurality of groups of first samples, and the plurality of groups of first samples comprise a plurality of sample audios, angle features associated with the plurality of sample audios, and a sample first weight and a sample second weight associated with each sample audio.

19. The terminal device of claim 15, wherein determining the second audio based on the plurality of first audios, the plurality of first target audios, and the non-target audios comprises:
processing, based on a second model, the plurality of first target audios and the non-target audios to obtain a plurality of target weights, the target weights being proportions of audios associated with the target direction in each frequency point of the first audio; and
determining a plurality of sub-audios based on the plurality of target weights and the plurality of first audios, and performing fusion processing on the plurality of sub-audios to obtain the second audio;
wherein the second model is obtained by training a plurality of groups of second samples, and the plurality of groups of second samples comprise a plurality of sample first target audios, a plurality of sample non-target audios associated with the plurality of sample first target audios, and a plurality of sample target weights.

20. The terminal device of claim 14, wherein determining the angle feature based on the plurality of first audios and the target direction comprises:
determining phase differences between the plurality of first audios to obtain a plurality of first phase differences;
determining a second phase difference associated with the target direction; and
determining the angle feature based on the second phase difference and the plurality of first phase differences.

21. The terminal device of claim 20, wherein determining the angle feature based on the second phase difference and the plurality of first phase differences comprises:
determining cosine similarities between the second phase difference and each first phase difference to obtain a plurality of cosine similarities; and
performing fusion processing on the plurality of cosine similarities to obtain the angle feature.

22. A non-transitory computer readable storage medium storing computer execution instructions that, when executed by a processor, implement acts for audio processing, the acts comprising:
obtaining a plurality of first audios captured by a plurality of audio capture devices;
determining an angle feature for indicating a proportion of a sound source in a target direction in each first audio based on the plurality of first audios and the target direction;
determining a second audio associated with the target direction based on the plurality of first audios and the angle feature; and
playing the second audio.

23. The non-transitory computer readable storage medium of claim 22, wherein determining the second audio associated with the target direction based on the plurality of first audios and the angle feature comprises:
determining a plurality of first target audios and non-target audios based on the plurality of first audios and the angle feature, the first target audios being audios associated with the first audios in the target direction, and the non-target audios being audios associated with the first audios in further directions; and
determining the second audio based on the plurality of first audios, the plurality of first target audios and the non-target audios.

24. The non-transitory computer readable storage medium of claim 23, wherein determining the plurality of first target audios and non-target audios based on the plurality of first audios and the angle feature comprises:
determining, based on the plurality of first audios and the angle feature, a plurality of first weights and a plurality of second weights associated with the plurality of first audios; and
determining the plurality of first target audios and the non-target audios based on the plurality of first weights, the plurality of second weights, and the plurality of first audios.

25. The non-transitory computer readable storage medium of claim 24, wherein determining the plurality of first target audios and the non-target audios based on the plurality of first weights, the plurality of second weights, and the plurality of first audios comprises:
determining the plurality of first target audios based on the plurality of first weights and the plurality of first audios; and
determining the non-target audios based on the plurality of second weights and the plurality of first audios.
